(19) United States
(12) Patent Application Publication
(10) Pub. No.: US 2024/0190178 A1
(43) Pub. Date: Jun. 13, 2024

(54) WHEEL

(71) Applicant: Brian Horowitz, Lake Forest, CA (US)

(72) Inventors: Brian Horowitz, Lake Forest, CA (US); William F. Ryczek, Pomona, CA (US); Thomas Wang, Alhambra, CA (US)

(73) Assignee: Brian Horowitz, Lake Forest, CA (US)

(21) Appl. No.: 18/078,678

(22) Filed: Dec. 9, 2022

(51) Int. Cl. B60C 11/03; B60C 11/01

(52) U.S. Cl. CPC B60C 11/0316; B60C 11/01; B60C 2011/0313

(57) ABSTRACT

A wheel having first and second side walls, first and second shoulders, a crown, a plurality of inner treads, and a plurality of first and second side lugs. The first and second side walls are opposed and define an interior cavity. The first and second shoulders have a generally circular shape and are located at an outer circumference of the first and second side walls, respectively. The crown is located between the first and second shoulders and has a generally concave shape. The plurality of inner treads are located around a periphery of the crown. The plurality of first side lugs are located on an outer surface of the first crown. The plurality of second side lugs are located on an outer surface of the second crown.

### FIELD OF THE INVENTION

The invention relates generally to products, such as wagons, that are designed to move along sandy surfaces, and more particularly, to a wheel that may be suitable for use on a beach.

### BACKGROUND OF THE INVENTION

It is known for basket-carrying wagons to include one or more pairs of wheels to enable the movement of articles or items that are useful or desirable at a specific location or event. For example, a basket-carrying wagon may be used to transport useful articles to the beach, a festival (such as a music festival) or fireworks exhibition or show.

When such wagons are used to carry items or traverse sandy soil, typical “beach” wheels may not be suitable for such conditions. Prior art wheels, especially when carrying substantial weight, may not be suitable. For instance, typical wheels may either dig or bite too deeply into the sandy soil and/or not have enough traction.

The present invention is aimed at one or more of the problems identified above

### BRIEF SUMMARY OF THE INVENTION

In a first aspect of the invention, a wheel having first and second side walls, first and second shoulders, a crown and a plurality of inner treads. Each of the first and second side walls have a generally circular shape. The first and second side walls are opposed and define an interior cavity. The first shoulder has a generally circular shape and is located at an outer circumference of the first side wall. The second shoulder has a generally circular shape and is located at an outer circumference of the second side wall. The crown is located between the first and second shoulders and has a generally concave shape. The plurality of inner treads are located around a periphery of the crown. Each inner tread has a first end located adjacent a junction between the first side wall and the crown and a second end located adjacent a junction between the second side wall and the crown.

In a second aspect of the invention, a wheel having first and second side walls, first and second shoulders, a crown, a plurality of inner treads, and a plurality of first and second side lugs is provided. Each of the first and second side walls has a generally circular shape. The first and second side walls are opposed and define an interior cavity. The first shoulder has a generally circular shape and being located at an outer circumference of the first side wall. The second shoulder has a generally circular shape and is located at an outer circumference of the second side wall. The crown is located between the first and second shoulders and has a generally concave shape. The crown defines a trough along an outer perimeter of the wheel. The plurality of inner treads are located around a periphery of the crown. Each tread has a first end located adjacent a junction between the first side wall and the crown and a second end located adjacent a junction between the second side wall and the crown. Each of the inner treads has a first side surface and a second side surface joined at a crest portion. The crest portion runs along an entire length of the respective inner tread. The plurality of first side lugs are located on an outer surface of the first shoulder. The plurality of second side lugs are located on an outer surface of the second shoulder. Each of the plurality of the first side lugs and the plurality of second side lugs include a first subset of side lugs and a second subset of side lugs, wherein the side lugs in the first subset alternative with the side lugs in the second subset, the side lugs being angled backward relative to a direction of travel associated with the wheel.

### BRIEF DESCRIPTION OF THE SEVERAL VIEWS OF THE DRAWINGS

These and other features and advantages of the present invention will become more readily appreciated when considered in connection with the following detailed description and appended drawings.

FIG. 1 is a perspective view of a wheel, according to an embodiment of the present invention.

FIG. 2 is a side view of the wheel of FIG. 1.

FIG. 3 is a front elevation view of the wheel of FIG. 1.

FIG. 4 is an isometric view of an inner tread of the wheel of FIG. 1.

FIG. 5 is a side view of the inner tread of FIG. 4.

### DETAILED DESCRIPTION OF THE INVENTION

Referring to the figures, wherein like numerals indicate like or corresponding parts throughout the several views, a wheel, or tire, 10, that is suitable for traversing sandy terrain, such as a beach, while carrying a load. The wheel 10 may be used with a wagon configured to carry items. One suitable wagon is disclosed in U.S. Pat. No. 11,388,999, issued on Jul. 19, 2022, which is hereby incorporated by reference. The disclosed wheel 10 may be embodied in different forms. For instance, the wheel 10 may be solid or hollow and may be composed from a flexible or semi-flexible material such as a plastic or (natural or synthetic) rubber, for example, as please provide the material from which the wheel is composed and any alternatives. The wheel 10 may be manufactured from Polyurethane foam using a molding process.

Alternatively, the wheel 10 may be composed from a combination of materials, such as, but not limited to, natural rubber, synthetic rubber, steel, nylon, silica (derived from sand), polyester, carbon black, petroleum, etc . . . . In addition, the wheel 10 may be pressurized or un-pressurized.

As shown, the wheel 10 includes first and second side walls 12, 14. Each of the first and second side walls 12, 14 have a generally circular shape. The first and second side walls 12, 14 are spaced apart and opposed opposite each other. The first and second side walls 12, 14 define an interior cavity 16. The interior cavity 16 is generally configured to receive a rim (not shown). Generally, the wheel 10 is mounted to the rim (not shown) (and fixed together) and rotate together about an axis 18. The wheel 10 and the rim may be mounted to an axle (not shown).

As shown, in the illustrated embodiment, the wheel 10 includes a first shoulder 20, a second shoulder 22, and a crown 24. The first shoulder 20 has a generally circular shape and is generally located at an outer circumference of the first side wall 12. An outer surface of the first shoulder 20 forms a raised portion between the first side wall 12 and the crown 24. The second shoulder 22 has a generally circular shape and is located at an outer circumference of the second side wall 14. An outer surface of the second shoulder 22 forms a raised portion between the first side wall 12 and the crown 24.

The crown 24 is located between the first and second shoulders 20, 22. As shown, the first and second side walls 12, 14 are spaced apart and, along with the first and second shoulders 20, 22 and the crown 24 for the generally donut-shaped wheel 10. The interior cavity 16 forms the “donut hole” center of the wheel 10 and may be open or closed to an interior of the wheel 10.

As shown, the crown 24 is generally concave and forms a trough 26 along an outer perimeter of the wheel 10. In the illustrated embodiment, the crown 24 is symmetrical between the first and second shoulder 20, 22 (divided by center plane 28). In other embodiments, the crown 24 may be unsymmetrical, i.e., the crown 24 may be different on opposite sides of the center plane 28.

The wheel 10 further includes a plurality of inner treads 30 located within, and spaced apart in, the trough 26 formed by the crown 24. In the illustrated embodiment, each inner tread 30 has a first end 30A located adjacent a junction between the first side wall 12 and the crown 24 and a second end 30B located adjacent a junction between the second side wall 14 and the crown 24. In one embodiment, each of the inner treads 30 has first and second side surfaces 30C, 30D joined at a crest portion 30E. As shown, the crest portion 30E runs along an entire upper length of the respective inner tread 30. Further, the crest portion 30E is at or below an upper surface of the first and second shoulders 20, 22.

In one embodiment, the crest portion 30E may be linear. Alternatively, the crest portion 30E may have first and second sloping portions 30E-1, 30E-2 joined at a central location 30E-3 generally located on the center plane 28.

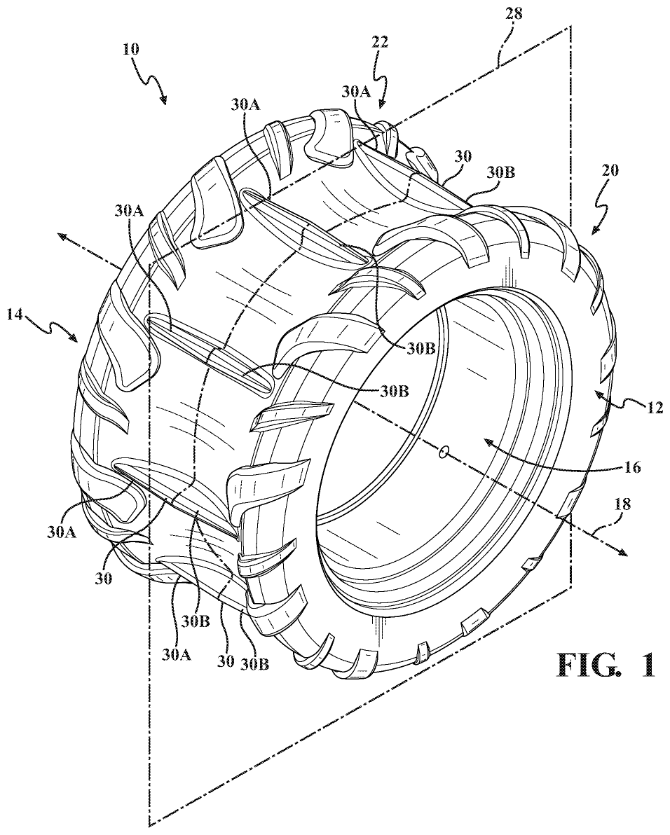

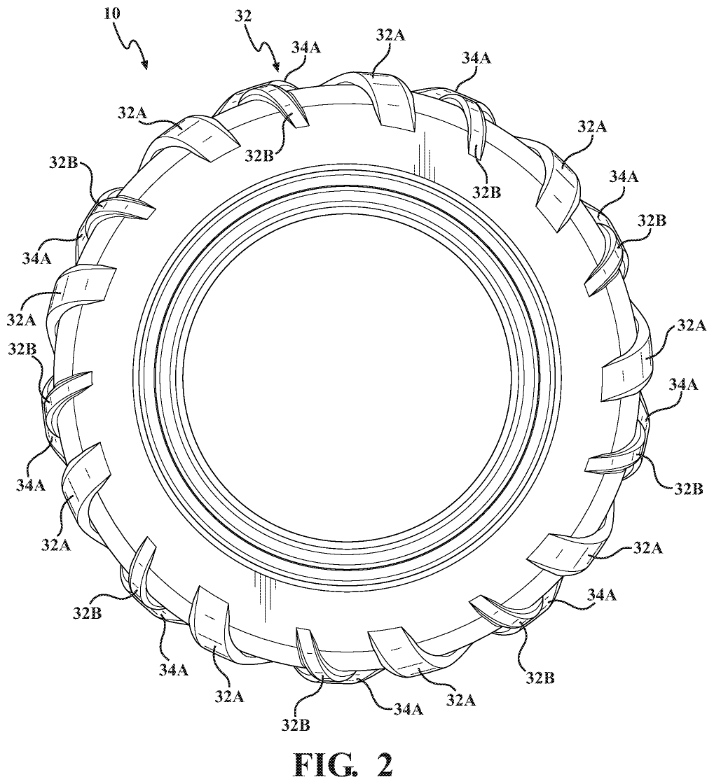

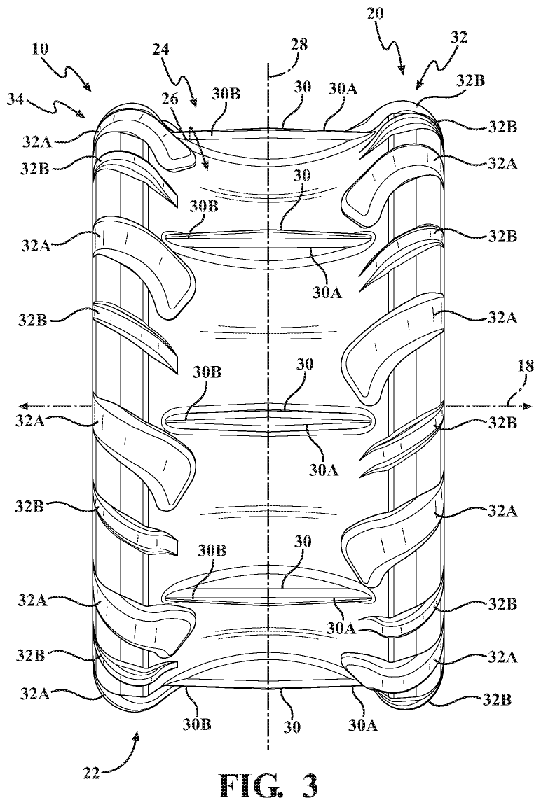

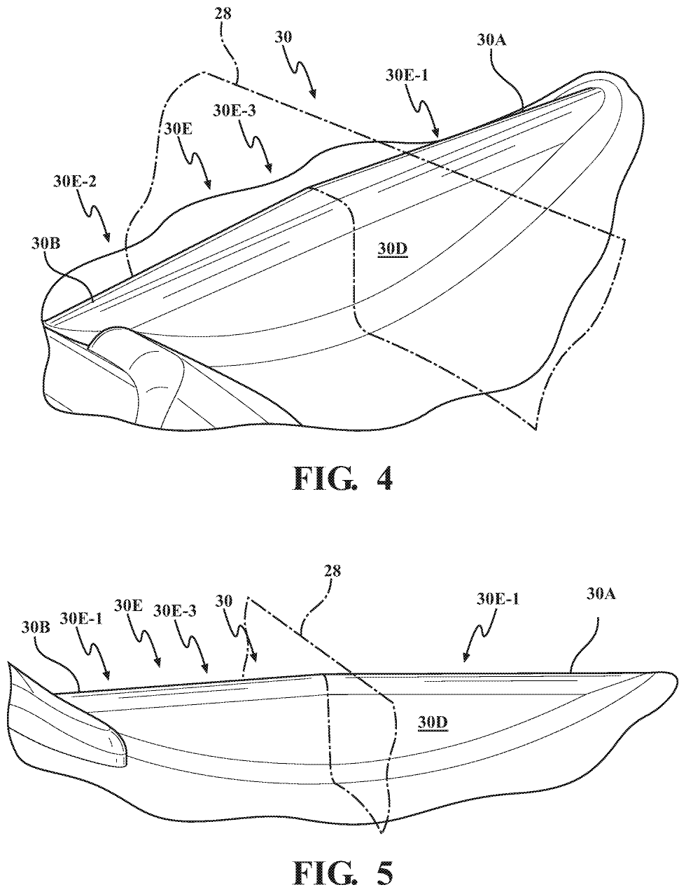

Returning to FIG. 1, the wheel 10 may further include a plurality of first side lugs 32 located on an outer surface of the first shoulder 20 and a plurality of second side lugs 34 located on an outer surface of the second shoulder 22. As shown in the illustrated embodiment, the side lugs 32, 34 may be generally flush with the respective side wall 12, 14, and gradually rise towards the respective shoulder 20, 22 such that the side lugs 32, 34 are raised from, or extend above, the outer surface of the respective shoulder 20, 22. In another embodiment, the side lugs 32, 34 are located on the respective shoulders 20, 22 and do not extend onto the side walls 12, 14,

In general, the inner treads 30 help provide traction to the wheel 10 when in sandy material or sand. There is a void between the inner treads 30 which traps sand therebetween, helping to prevent the wheel 10 from digging itself into the sand. The inner treads 30 push the trapped sand helping the wheel 10 turn without getting stuck in the sand.

The plurality of first and second side lugs 32, 34 assist in providing traction in sandy soils, and also, traction on other types of surfaces.

In the illustrated embodiment, both the plurality of the first side lugs 32 and the plurality of second side lugs 34 include a first subset of side lugs 32A, 34A, and a second subset of side lugs 32B, 34B. As shown, the side lugs 32A, 34A in the first subset alternative with the side lugs 32B, 34B. Further, the side lugs 32A, 34A, 32B, 34B may be generally angled backward relative to one direction of travel associated with the wheel 10, e.g., forward.

The side lugs 32A, 34A in the first subset may be larger than the side lugs 32B, 34B in the second subset.

In addition, each side lug 32A, 34A, 32B, 34B is positioned opposite a side lug 32A, 34A, 32B, 34B on the opposing shoulder 20, 22. In the illustrated embodiment, a side lug 32A, 34A in the one on the subsets is opposite a side lug 32B, 34B in the other subset. In other words, each larger side lug 32A, 34A is opposite a smaller side lug 32B, 34B.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. A wheel centered on an axis, comprising:
first and second side walls, each of the first and second side walls have a generally circular shape, the first and second side walls being opposed and defining an interior cavity;
a first shoulder having a generally circular shape and being located at an outer circumference of the first side wall;
a second shoulder having a generally circular shape and located at an outer circumference of the second side wall;
a plurality of first side lugs located on, and extending from, an outer surface of the first shoulder;
a plurality of second side lugs located on, and extending from, an outer surface of the second shoulder;
a crown being located between the first and second shoulders and having a generally concave shape and being divided by a center plane; and,
a plurality of inner treads located around a periphery of the crown, each inner tread having a crest portion, a first end located adjacent a junction between the first side wall and the crown, and a second end located adjacent a junction between the second side wall and the crown, wherein each of the plurality of first side lugs and the plurality of second side lugs has a first end and a second end, the first end located adjacent a junction between an associated side wall and the crown, each of the plurality of first side lugs and the plurality of second side lugs extending from the first end towards the center plane and ending at the second end, wherein each of the plurality of first side lugs and the plurality of second side lugs ends before crossing the center plane, wherein a junction between each inner tread and the crown at the center plane is closer to the axis than the second end of each of the first and second side lugs, wherein the crest portion is at or below an upper surface of the first and second shoulders.

2. (canceled)

3. The wheel, as set forth in claim 1, wherein each of the inner treads has a first side surface and a second side surface joined at the crest portion.

4. The wheel, as set forth in claim 3, wherein the crest portion runs along an entire length of a respective inner tread.

5. The wheel, as set forth in claim 4, wherein the crest portion is linear.

6. The wheel, as set forth in claim 4, wherein the crest portion includes first and second sloping portions joined at a central location.

7. The wheel, as set forth in claim 1, wherein the crown defines a trough along an outer perimeter of the wheel.

8. The wheel, as set forth in claim 7, wherein the crown is symmetrical between the first and second shoulders.

9. The wheel, as set forth in claim 1, wherein each of the plurality of first side lugs and the plurality of second side lugs include a first subset of side lugs and a second subset of side lugs.

10. The wheel, as set forth in claim 9, wherein the side lugs in the first subset alternate with the side lugs in the second subset.

11. The wheel, as set forth in claim 10, the side lugs in the first subset and the side lugs in the second subset are angled backward relative to a direction of travel associated with the wheel.

12. (canceled)

13. The wheel, as set forth in claim 9, wherein the side lugs in the first subset are larger than the side lugs in the second subset.

14. The wheel, set forth in claim 13, wherein each side lug on one of the first and second shoulders is positioned opposite a side lug on the other of the first and second shoulders.

15. The wheel, as set forth in claim 13, wherein each side lug on one of the first and second subsets is positioned opposite a side lug in an other one of the first and second subsets.

16. A wheel centered on an axis, comprising:
first and second side walls, each of the first and second side walls have a generally circular shape, the first and second side walls being opposed and defining an interior cavity;
a first shoulder having a generally circular shape and being located at an outer circumference of the first side wall;
a second shoulder having a generally circular shape and located at an outer circumference of the second side wall;
a crown being located between the first and second shoulders and having a generally concave shape, wherein the crown defines a trough along an outer perimeter of the wheel;
a plurality of inner treads located around a periphery of the crown, each inner tread having a first end located adjacent a junction between the first side wall and the crown and a second end located adjacent a junction between the second side wall and the crown, wherein each of the inner treads has a first side surface and a second side surface joined at a crest portion, wherein the crest portion runs along an entire length of the respective inner tread and is at or below an upper surface of the first and second shoulders;
a plurality of first side lugs located on, and extending from, an outer surface of the first shoulder; and,
a plurality of second side lugs located, and extending from, on an outer surface of the second shoulder, wherein each of the plurality of first side lugs and the plurality of second side lugs include a first subset of side lugs and a second subset of side lugs, wherein the side lugs in the first subset alternate with the side lugs in the second subset, the side lugs in the first subset and the side lugs in the second subset being angled backward relative to a direction of travel associated with the wheel, wherein each of the plurality of first side lugs and the plurality of second side lugs has a first end and a second end, the first end located adjacent a junction between an associated side wall and the crown, each of the plurality of first side lugs and the plurality of second side lugs extending from first end towards a center plane and ending at the second end, wherein each of the plurality of the first side lugs and the plurality of second side lugs ends before the crossing the center plane, wherein a junction between each inner tread and the crown at the center plane place is closer to the axis than then the second end of each of the first and second side lugs.

17. The wheel, as set forth in claim 16, wherein the crest portion is linear.

18. The wheel, as set forth in claim 17, wherein the crest portion includes first and second sloping portions joined at a central location.

19. The wheel, as set forth in claim 16, wherein the side lugs in the first subset are larger than the side lugs in the second subset.

20. The wheel, set forth in claim 19, wherein each side lug on one of the first and second shoulders is positioned opposite a side lug on the other of the first and second shoulders.

21. The wheel, as set forth in claim 20, wherein each side lug on one of the first and second subsets is positioned opposite a side lug in an other one of the first and second subsets.
